(19) United States
(12) Patent Application Publication
(10) Pub. No.: US 2022/0402746 A1
(43) Pub. Date: Dec. 22, 2022

(54) Full-Service Autonomous Gas Station

(71) Applicant: Jean-Paul Trott, Canton, OH (US)

(72) Inventor: Jean-Paul Trott, Canton, OH (US)

(21) Appl. No.: 17/845,595

(22) Filed: Jun. 21, 2022

Related U.S. Application Data
(60) Provisional application No. 63/212,874, filed on Jun. 21, 2021.

(51) Int. Cl. B67D 7/04

(52) U.S. Cl. CPC B67D 7/0401; B67D 2007/0419; B67D 2007/0463; B67D 2007/0474; B67D 2007/0442

(57) ABSTRACT

The present invention relates to a novel full-service autonomous gas station comprising of a plurality of drive-through service bay lanes. The gas station includes an autonomous fueling section and a pick-up area in each service bay lane for autonomous fueling of the vehicle and delivery of ordered store items. The gas station determines the position of a vehicle relative to a fuel refilling robotic arm before automatically filling fuel in fuel tank of the vehicle. A voice-activated digital menu display board displays store items that can be ordered via a smartphone application or a voice-input system by a user of the car while remaining within the car. The fuel is also refilled without requiring the user to exit the vehicle. A second robotic arm provides ordered item(s) to the user and thus obviates the need of the user to exit the vehicle throughout the station.

### CROSS-REFERENCE TO RELATED APPLICATION

The present application claims priority to, and the benefit of, U.S. Provisional Application No. 63/212,874, which was filed on Jun. 21, 2021 and is incorporated herein by reference in its entirety.

### FIELD OF THE INVENTION

The present invention relates generally to the field of fueling stations. More specifically, the invention is related to a full-service autonomous gas station that enables a driver or an operator of a vehicle to remain within the vehicle during the process of fueling the tank of the vehicle and ordering and receiving store items. The station is configured to provide fuel and store items automatically, while providing drivers privacy, safety, personal space, protection and peace of mind by enabling them to remain in the vehicle. The station automatically takes the vehicle from a fueling position to a pick-up area. The station provides multiple independent lanes for commercial and personal vehicles. Accordingly, the present disclosure makes specific reference thereto. Nonetheless, it is to be appreciated that aspects of the present invention are also equally applicable to other like applications, devices and methods of manufacture.

### BACKGROUND

By way of background, fueling or gas stations are commonplace in today's society. These include a plurality of fuel pumps that dispenses one or more different types of fuel, such as gasoline and diesel. Presently, a vehicle operator stops his or her vehicle for the vehicle tank to be filled. The operator/driver of the vehicle has to exit the vehicle to open the fuel door and remove the fuel cap, pay for the fuel and then dispense the fuel. Usually, the vehicle operator may be required to talk and interact with personnel of the fuel station and may need to walk from the vehicle to the store personnel to pay for the fuel. This is undesirable and unsafe for both the vehicle operator and the store personnel in times of pandemics. This may lead to cross-contamination and infections. Further, this is discomforting for the vehicle operator as the vehicle operator may feel vulnerable to germs, theft, harassment and inclement weather when visiting a gas station. At night, this can be unsafe for the vehicle operator and the vehicle operator may face vandalism or theft.

In many cases, the operator needs to handle a fuel arm and nozzle from the pump and place the nozzle into the fuel intake of his or her vehicle to dispense the fuel. Some operators may not know how to use the nozzle, and further the fuel handle, keypad and door handles can be contaminated which may lead to cross-contamination.

Conventional gas stations provide food and other convenience items for the users. Generally, a user has to go into the store or ask a store person for a takeaway order. This includes an interaction of the user/operator of the vehicle with the store personnel and may lead to contamination. People desire a way to order and collect items while remaining in the vehicle. Further, a vehicle operator has to pay for the fuel and the ordered items separately at the fuel station and the store. This is not only time-consuming but is discomforting for the user. People desire a more convenient way of paying for both the fuel and food/convenience items.

Therefore, there exists a long felt need in the art for an improved gas station that enables refueling and ordering of items in an autonomous or automated manner. There is also a long felt need in the art for an autonomous gas station that does not require a driver to exit the vehicle for refueling. Additionally, there is a long felt need in the art for a gas station that enables a single and automated payment for both the fuel and other food/store/convenience items ordered by the driver or operator of the vehicle. Moreover, there is a long felt need in the art for an improved gas station that eliminates manual use of a fuel pump by a vehicle operator of the vehicle. Further, there is a long felt need in the art for a fuel station that automatically receives payment prior to delivering fuel and food items. Finally, there is a long felt need in the art for an improved gas station that affords drivers privacy, safety, personal space, protection and peace of mind by enabling them to remain in the vehicle.

The subject matter disclosed and claimed herein, in one embodiment thereof, comprises a full-service autonomous gas station. The station features a fuel system having a fuel refilling robotic arm for dispensing fuel into a fuel inlet of a vehicle, the fuel refilling robotic arm is configured to open the fuel door and remove the fuel gas cap of the vehicle, dispense fuel when the alignment of the fuel inlet of the vehicle is aligned with the nozzle, remove the nozzle after refueling, close the gas cap and fuel door. A voice-activated digital menu board displays a list of items wherein one or more items can be ordered by the driver or operator of the vehicle. A pick-up area is positioned ahead of the fuel system along a lane and includes a food/item providing a robotic arm for automatically delivering ordered items from the voice-operated menu board by the user. A drive-through bay takes the vehicle from the fuel system to the pick-up area when the fuel is refilled in the vehicle. A payment system is installed for receiving and authorizing payment information from the driver or operator of the vehicle, and a voice input system for receiving voice input from the driver or operator of the vehicle.

In this manner, the gas station of the present invention accomplishes all of the forgoing objectives and provides users with a safe and convenient method for visiting a gas station that does not require the driver to exit the vehicle. The station includes multiple lanes that can be independently used by vehicles for refilling fuel and ordering store items. Robotic arms are provided for fueling and delivery of items. The system affords drivers privacy, safety, personal space, protection and peace of mind by enabling them to remain in the vehicle.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a full-service autonomous gas station. The full-service autonomous gas station is configured to provide a safe and convenient method for visiting a gas station that does not require the driver or operator to exit the vehicle. The station comprising a fuel system having a fuel-refilling robotic arm for dispensing fuel into a fuel inlet of a vehicle, the fuel-refilling robotic arm is configured to open the fuel door and gas cap of the vehicle, and dispense fuel when the alignment of the fuel inlet of the vehicle is aligned with the nozzle. A voice-operated menu board displaying a list of items wherein one or more items can be ordered by the driver or operator of the vehicle; a pickup area having a food-providing robotic arm for automatically delivering order items from the voice-operated menu board by the user, a drive-through bay for guiding the vehicle from the fuel system to the pick-up area when the fuel is refilled in the vehicle, a payment system for receiving and authorizing payment information from the driver or operator of the vehicle and a voice input system for receiving voice input from the driver or operator of the vehicle.

The autonomous gas station further includes a food station software application configured to install in a handheld electronic device and is used for ordering fuel, ordering food items and payment of fuel and food items.

The subject matter disclosed and claimed herein, in another embodiment thereof, comprises an autonomous full-service gas station that fuels a vehicle and provides ordered food items in an automated manner such that an operator of the vehicle remains within the vehicle at the gas station. The autonomous full-service gas station includes a central controller configured to receive a fuel and food item order from the operator, determine that the vehicle is in an aligned position with a fuel-refilling robotic arm nozzle, determine that a payment made by the operator is authorized, provide an instruction to the fuel refilling robotic arm to open the fuel door and gas cap of the vehicle, dispense the gas or fuel and close the gas cap and fuel door, transmit an instruction to a food module to package the ordered food items, and transmit an instruction to a food-providing robotic arm positioned at a pick-up area to deliver the food items to the operator while the operator remains within the vehicle. The controller further actuates the drive-through bay mechanism to travel or transport the vehicle automatically from the aligned position to the pick-up area.

In yet another embodiment, the controller receives payment information from a payment system and order information from a voice input system or a software application installed in the operator's electronic device.

In yet another embodiment, a method for autonomous filling of gas in a vehicle and delivering ordered food items is described. The method includes the step of positioning a vehicle in a first position for fueling the fuel tank of the vehicle automatically, then, checking the payment authorization of the user of the vehicle and if authorized, opening by a robotic arm the fuel door and gas cap of the vehicle, dispensing fuel into fuel tank, and closing the fuel door and gas cap. The method further includes receiving an order of store items from the user and providing the ordered items in an autonomous manner by a second robotic arm at a second position wherein the vehicle is automatically travelled or transported in a neutral position from the first position to the second position.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one lane of a full-service autonomous gas service station of the present invention in accordance with the disclosed architecture;

FIG. 2 illustrates a perspective view of the full-service autonomous gas service station of the present invention having a plurality of lanes in accordance with the disclosed architecture;

FIG. 3 illustrates a schematic view of various elements of the full-service autonomous gas station of the present invention in accordance with the disclosed architecture;

FIG. 4 illustrates a schematic diagram of the full-service autonomous gas station of the present invention accessed using refuel mobile application installed in an electronic device in accordance with the disclosed architecture;

FIG. 5 illustrates a perspective view of a fuel pump used for refilling the fuel tank of a vehicle in accordance with the disclosed architecture; and

FIG. 6 illustrates a perspective view showing autonomous delivery of ordered items to a driver or operator of the vehicle without requiring him or her to exit the vehicle in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an improved gas station that enables fuel refilling and ordering items in an automated or autonomous manner. There is also a long felt need in the art for an autonomous gas station that does not require a driver to exit the vehicle. Additionally, there is a long felt need in the art for a gas station that enables a single and automated payment for both the fuel and other items ordered by the driver or operator of the vehicle. Moreover, there is a long felt need in the art for an improved gas station that eliminates manual use of a fuel pump by an operator of the vehicle. Further, there is a long felt need in the art for a fuel station that automatically receives payment prior to delivering fuel and food items. Finally, there is a long felt need in the art for an improved gas station that affords drivers privacy, safety, personal space, protection and peace of mind by enabling them to remain in the vehicle

The present invention, in one exemplary embodiment, is a novel autonomous full-service gas station. The autonomous full-service gas station includes a central controller configured to receive a fuel and food item order from the vehicle operator, determine that the vehicle is in an aligned position with a fuel-refilling robotic arm nozzle, determine that a payment made by the operator is authorized, provide an instruction to the fuel-refilling robotic arm to open the fuel door and gas cap of the vehicle, dispense the gas or fuel and close the gas cap and fuel door, transmit an instruction to a food module to package the ordered food items, and transmit an instruction to a food-providing robotic arm positioned at a pick-up area to deliver the food items to the operator while the operator remains within the vehicle. The controller further actuates the drive-through bay mechanism to travel or transport the vehicle automatically from the aligned or refueling position to the pickup area.

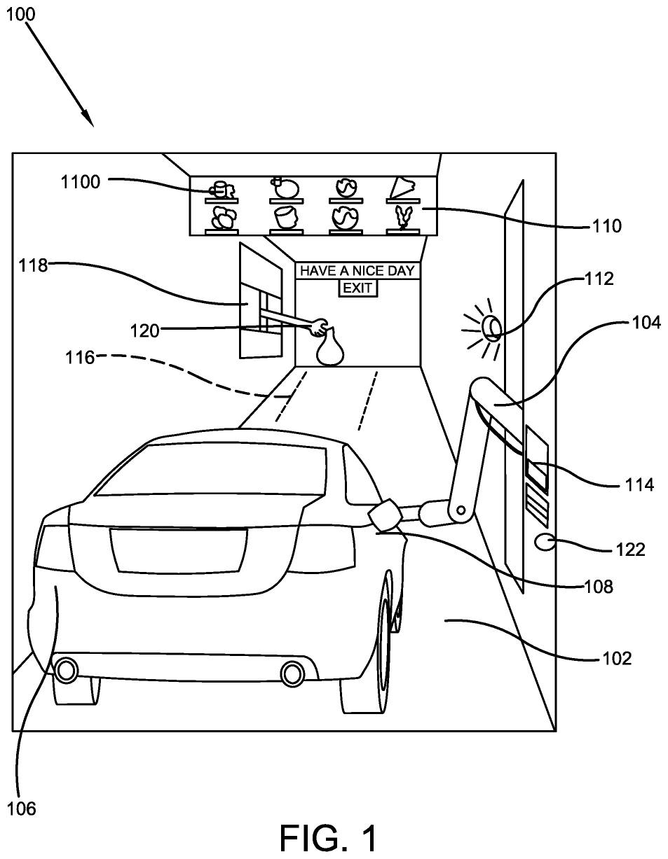

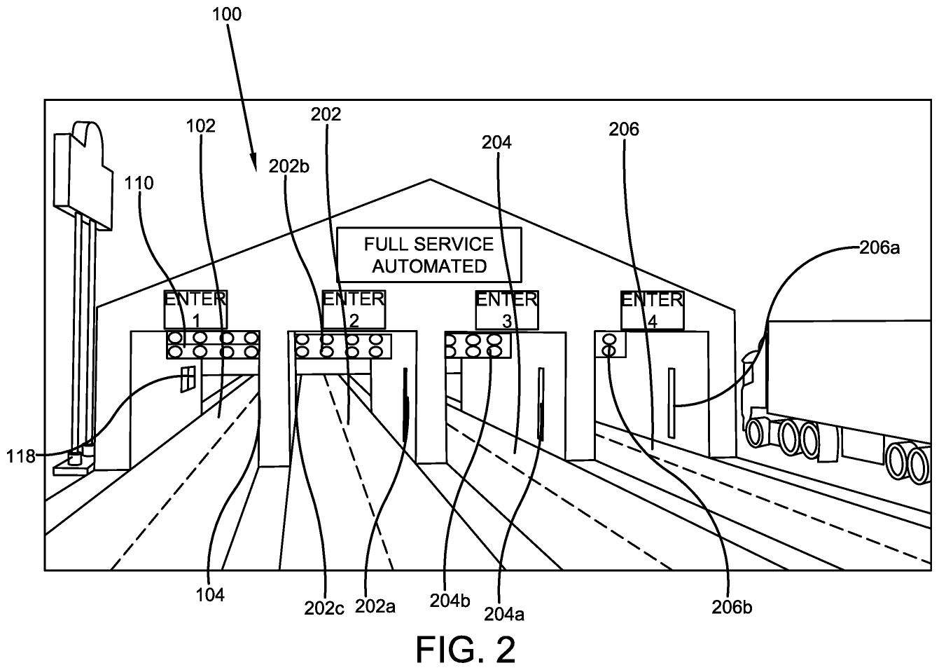

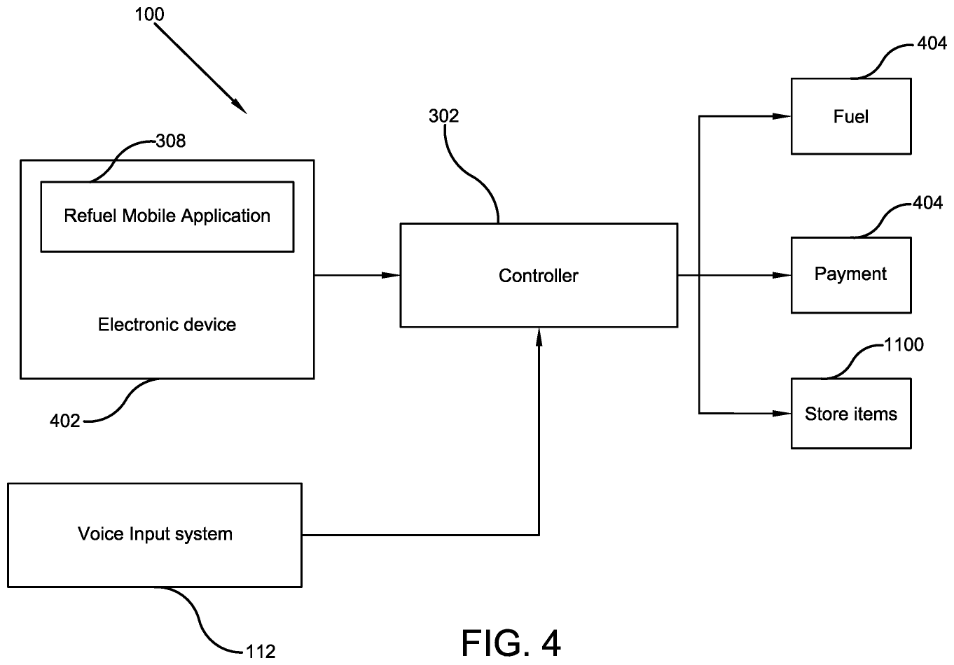

Referring initially to the drawings, FIG. 1 illustrates a perspective view of one lane of the full-service autonomous gas service station of the present invention in accordance with the disclosed architecture. The autonomous gas service station 100 is designed to fuel a vehicle such that a user remains within a vehicle during fueling and receiving ordered food and other items from a store of the station 100. More specifically, the gas station 100 includes a plurality of separate lanes (as shown in FIG. 2) for various types of personal and commercial vehicles. In the present embodiment, only a single lane 102 is shown in FIG. 1 for description purposes. The lane 102 includes a fuel-refilling robotic arm 104 that autonomously fills fuel in the fuel tank 108 of the vehicle 106. Further, the lane 102 includes a food and other convenience voice-activated menu 110 that displays a plurality of food items 1100 for ordering by the user sitting in a vehicle 106. The food and other items 1100 can be ordered using a voice-input system 112 positioned near the fuel refilling robotic arm 104. The payment for the fuel and the ordered food items 1100 can be done automatically using the payment system 114 or through a companion software application (shown in FIG. 4) of the service station 100. The software application is configured to be installed in a handheld electronic device. The payment system 114 is installed near the fuel refilling robotic arm 104 for facilitating payment for fuel and ordered items. For example, a customer while remaining in the vehicle can provide a credit card to the automatic payment system and pay for the gas and the purchased products.

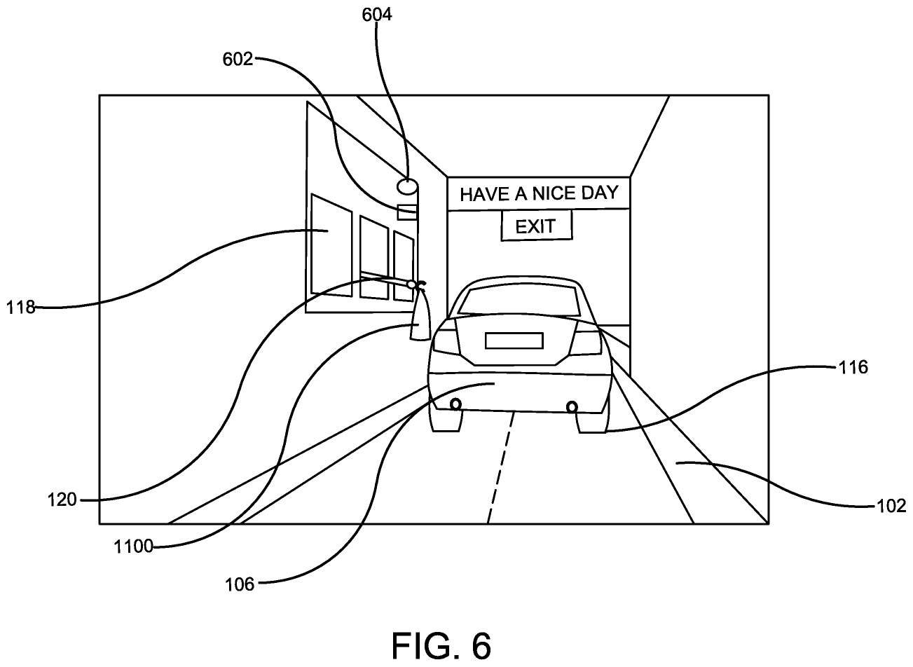

The lane 102 includes a drive-through bay 116 from the fuel-refilling robotic arm 104 to an item pick-up point 118 where a food or convenience item providing robotic arm 120 is disposed. The drive-through bay 116 enables the vehicle 106 to automatically go from the fuel-refilling robotic arm 104 to the item pick-up point 118. Preferably, the drive-through bay 116 can include a movable platform such as movable metal platform or conveyer belt. Alternatively, the vehicle 106 can be manually driven by the passenger to the pick-up point 118 from the fuel-refilling robotic arm 104. Position of the vehicle 106 at the fuel-refilling robotic arm 104 is also referred to as the first position or initial position in the present disclosure. The food item providing robotic arm 120 is configured to provide ordered items of the user and the user can pick up items while remaining inside the vehicle. The position of the vehicle 106 at the pick-up area 118 is also referred to as the second position or final position in the present disclosure (as shown in FIG. 6).

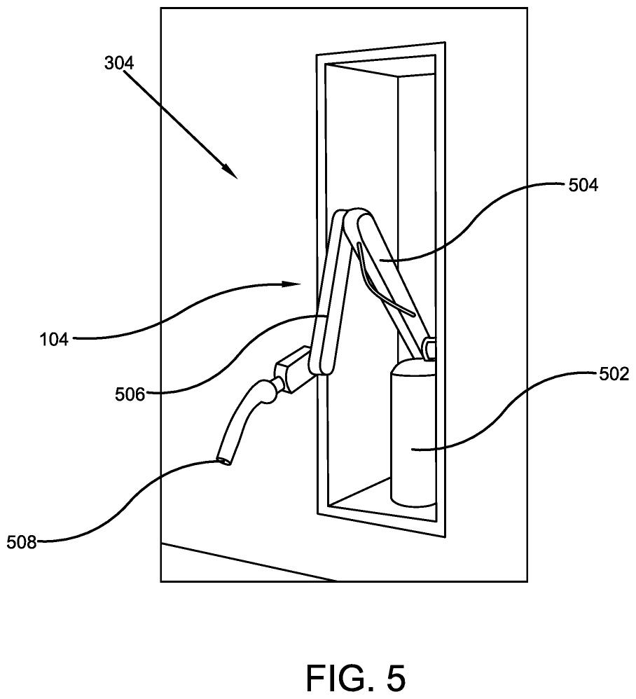

The lane 102 includes a sensor system 122 that determines if the vehicle 106 is in alignment with the fuel-refilling robotic arm 104 in a proper orientation. The sensor system 122 enables the robotic arm's nozzle to refill the tank of the vehicle 106 when the vehicle 106 and the nozzle (shown in FIG. 5) are aligned with each other.

FIG. 2 illustrates a perspective view of the full-service autonomous gas service station of the present invention having a plurality of lanes in accordance with the disclosed architecture. As stated earlier, the autonomous gas station 100 includes a plurality of separate and independent lanes shown as 102, 202, 204, 206 in the present embodiment. It should be appreciated that each lane 102, 202, 204, 206 provides automated features of refilling of the fuel tank, ordering of food items and delivery of the ordered food items as described in FIG. 1. The gas station 100 can have any number of lanes as per the requirements of the authorities and users. Each lane 102, 202, 204, 206 includes its own fuel-refilling robotic arm, voice-operated menu display, and a pick-up area. As shown, the first lane 102 includes the fuel robotic arm 104, the menu display board 110 and the pickup point 118. Similarly, the second lane 202 includes fuel robotic arm 202a, the menu display board 202b, and the pick-up point 202c. The third lane 204 includes fuel robotic arm 204a, the menu display board 204b, and the corresponding pick-up point (not shown). The fourth lane 206 includes fuel robotic arm 206a, the menu display board 206b, and the pick-up point (not shown). It should be appreciated that all the lanes have all the features of the first lane 102 described in FIG. 1 and independent vehicles can be operated simultaneously in the lanes 102,202,204,206.

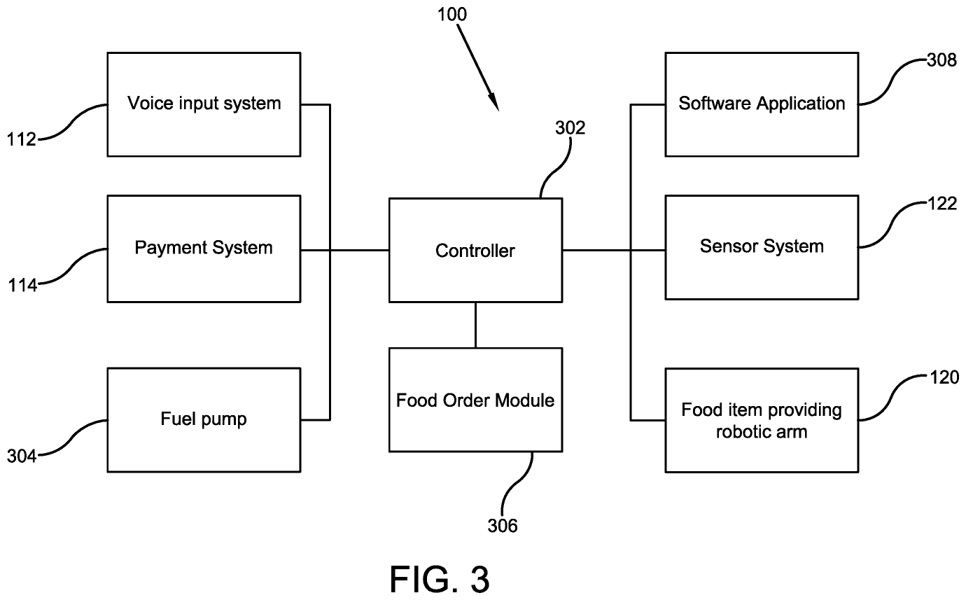

FIG. 3 illustrates a schematic view of various elements of the full-service autonomous gas station of the present invention in accordance with the disclosed architecture. The autonomous gas station 100 has a central controller 302 that manages and controls operations of various components and sensors of the station 100. The controller 302 is configured to receive information from components and accordingly instruct one or more components to perform a specific task. The controller 302 is configured to receive voice-input of the user from the voice-input system 112 indicating the order of fuel and other items. The controller 302 based on the request of the operator/driver activates the fuel pump 304 to automatically open the fuel inlet of the vehicle and dispense the fuel into the fuel tank of the vehicle. The fuel pump 304 includes the fuel-refilling robotic arm for dispensing the fuel or gas. It should be noted that the controller 302 also receives information from the sensor system 122 to check the alignment of the vehicle with the nozzle of the fuel-refilling robotic arm before actuating dispensing of the fuel in the vehicle. The sensor unit 122 can be a camera, a laser or any other type of alignment sensor that is configured to detect alignment of the fuel inlet of the vehicle with the nozzle of the fuel pump's robotic arm. In situations wherein the sensor unit 122 does not detect the desired position of the vehicle, then the sensor unit 122 may indicate to the driver in the form of a visual or audible alarm and may also assist the driver to align the car with the nozzle of the fuel pump.

The controller 302 provides order information of the user to a food order module 306 of the store of the gas station 100 and the food order module is further configured to provide a package containing ordered items of the user. The food order module 306 can be a part of a store of the station 100 and is configured to manage all the orders received from the voice-activated menu board. Then, the controller 302 actuates the food providing robotic arm 120 positioned at the pick-up area for providing the packaged food or convenience items to the user who has ordered the items while sitting in the vehicle.

Order and payment information from the software application 308 may also be received by the central controller 302, and based on the received request the controller 302 provides instructions to the fuel pump 304, food order module 306 and food item-providing robotic arm 120. The payment system 114 installed near the refilling robotic arm is also configured to provide a notification signal to the controller 302 indicating successful or unsuccessful payment authorization of the user. A user can scan a QR code or insert the card into the payment system 114 for paying for the fuel and the food items. Only after a successful authorization of the payment being received by the controller 302, the fuel pump 304 and food module 306 are subsequently activated.

The controller 302 can include a communications circuit for communicating with one or more of the other systems and components. The controller 302 may include an antenna to facilitate wireless communications. The controller 302 may also be wired to one or more of the components of the station 100. The controller 302 is also configured to provide a plurality of instructions to the vehicle operator, such as to turn off the ignition switch while refilling the fuel tank. The instructions can be provided through visual and/or audible means to the user.

In one embodiment of the present invention, each lane can have tire pressure sensors for detecting pressure in one or more tires of the vehicle. In cases where low pressure is detected, the pressure sensor sends a control signal to the controller for activating a built-in pressure mechanism to pump pressurized air in one or more tires of the vehicle.

FIG. 4 illustrates a schematic diagram of the full-service autonomous gas station of the present invention accessed using the refuel mobile application installed in an electronic device in accordance with the disclosed architecture. The automatic gas station 100 is designed to enable drivers to remain safely in their vehicles while visiting the fuel station and enables them to place their order related to the fuel, or store items such as food or beverage items using a refuel mobile application installed in the electronic device 402. The automatic refueling system 100 eliminates the need for the driver to exit from the vehicle for placing an order for the fuel or store items. The companion autonomous gas station software application 308 provides users with options to order fuel and store items in addition to a payment interface for making payments to the gas station 100. When a driver requests fuel or gas 404 through the software application 308, the controller 302 of the autonomous gas system 100 receives the user request through a communication network such as the Internet (not shown). Similarly, the autonomous gas system 100 enables users to place store items/food items 1100 and payment information 404 using the application 308.

The refuel mobile application 308 enables the user to select a type of fuel such as diesel, petrol and others. The refuel mobile application 308 also enables the driver or operator to select items such as food, beverages and other such type of items 1100 from the store and enables customers to place their orders for same.

It should be appreciated that the refuel mobile application 308 can enable users to track their refueling process and consumption and can also alert users in case the fuel tank of their vehicle is full. The refuel mobile application 308 also provides the user with a receipt of the fuel having information related to the price of the fuel, volume of the fuel or any other such type of information.

The voice-input system 112 installed near the fuel-refilling robotic arm 104 is also used for inputting voice commands for ordering fuel and food items. The menu board installed in each lane is voice-operated and the voice-input system receives voice-input from a user sitting in the vehicle. The user can provide voice-input for ordering one or more items displayed on the display board and the fuel. The voice-input system includes an automatic speech recognition (ASR) system for understanding user voice-input. The voice-input is transmitted to the food order processing module (as best shown in FIG. 4) for processing order of the user.

FIG. 5 illustrates a perspective view of the fuel pump 304 used for refilling the fuel tank of a vehicle in accordance with the disclosed architecture. As shown in FIG. 5, the fuel pump 304 includes the fuel-refilling robotic arm 104 that is designed to dispense fuel in the vehicle. The fuel pump 304 includes a fuel tank 502 connected to a first arm 504 of the robotic arm 104. The robotic arm 104 also includes a second arm portion 506 that has a nozzle 508. The nozzle 508 is used for opening the fuel door and fuel inlet of a vehicle to refill fuel in the vehicle. The first arm 504 and the second arm 506 are pivotally-movable relative to each other, thereby allowing the nozzle 508 to be positioned vertically-aligned with the fuel inlet of the vehicle. In use, as a vehicle enters the autonomous gas station and is positioned in alignment with the robotic arm 104, the robotic arm 104 opens the fuel door and removes the fuel cap of the vehicle. Once the fuel cap of the vehicle is removed, the robotic arm 104 positions the nozzle 508 to enter the fuel inlet of the vehicle. Then, based on the payment made by the user, the fuel is refilled and once the refilling is completed, the robotic arm takes out the nozzle 508 and gently closes the cap and fuel door of the fuel tank of the vehicle.

It should be appreciated that the fuel pump 304 is integrated with an intelligent auto-shut feature that enables the shutdown of the fuel flow to avoid spillage from the tank of the vehicle. For example, as the fuel level inside the vehicle's fuel tank touches the nozzle placed inside the fuel tank, the robotic arm 104 stops dispensing the fuel flow from the tank. The fuel pump may include various aspects, such as servo motors and linear actuators, and may include the same or different configurations for providing an effective and accurate dispensing of fuel.

The robotic arm 104 may also have a Hall Effect sensor (not shown) used in positioning the nozzle 508. The Hall Effect sensor detects the contact between the nozzle 508 and the fuel inlet of the vehicle to confirm docking of the nozzle 508. This provides feedback to the robotic arm 104 to perform the required door opening/closing, positioning and refueling tasks.

FIG. 6 illustrates a perspective view showing autonomous delivery of ordered items to a driver or operator of the vehicle without requiring him or her to exit the vehicle in accordance with the disclosed architecture. As stated earlier, the drive-through bay 116 of the lane 102 can automatically move or transport the vehicle 106 from the first position of the vehicle at the fuel point to the pick-up area 118. In operation, once the fueling process of the vehicle 106 is complete, the vehicle 106 is pulled or transported to the pick-up area 118 automatically by the bay 116 of the lane 102. When the vehicle 106 reaches the pick-up area 118, a motion sensor 602 detects the motion of the vehicle 106 enabling the food-providing robotic arm 120 to provide the items 1100 to the driver/operator of the vehicle 106 without requiring the operator to exit the vehicle 106. As the vehicle 106 reaches to the pick-up area 118, the robotic arm 120 provides the vehicle operator with the ordered items 1100 which obviates the need for the vehicle operator to leave his or her car 106. A high-resolution camera sensor 604 at the pick-up area 118 provides a scan of the license plate of the vehicle, thereby allowing an additional authentication of payment information. Once the authentication is successful, then an automatic barrier (not shown) is opened, thereby allowing the vehicle 106 to leave the station 100.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “gas station”, “full service autonomous gas station”, “autonomous gas station”, and “station” are interchangeable and refer to the full-service autonomous gas station 100 of the present invention.

Notwithstanding the forgoing, the full-service autonomous gas station 100 of the present invention can be of any suitable size and configuration as is known in the art without affecting the overall concept of the invention, provided that it accomplishes the above-stated objectives. One of ordinary skill in the art will appreciate that the size, configuration and material of the full-service autonomous gas station 100 as shown in the FIGS. are for illustrative purposes only, and that many other sizes and shapes of the full-service autonomous gas station 100 are well within the scope of the present disclosure. Although the dimensions of the full-service autonomous or automated gas station 100 are important design parameters for user convenience, the full-service autonomous or automated gas station 100 may be of any size that ensures optimal performance during use and/or that suits the user's needs and/or preferences.

As used herein, the terms “having”, “containing”, “including”, “comprising” and the like are open-ended terms that indicate the presence of stated elements or features, but do not preclude additional elements or features. The articles “a”, “an” and “the” are intended to include the plural as well as the singular, unless the context clearly indicates otherwise.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An autonomous service station for refueling a vehicle, the autonomous service station comprising:
a service station including a service bay lane, wherein said service bay lane includes a first automated robotic arm at a first position for autonomously refueling a vehicle;
a sensor system for determining an alignment of the vehicle in said service bay lane, wherein said sensor system determines alignment of the vehicle with said first automated robotic arm;
said sensor system aligns a nozzle of said first automated robotic arm with a fuel tank inlet of the vehicle;
wherein said first automated robotic arm connected to a fuel pump;
a central controller for activating said fuel pump based on a command of a vehicle operator; and
said first automated robotic arm refuels the vehicle when said vehicle operator commands said fuel pump and when said sensor system confirms alignment of said nozzle and said fuel tank inlet.

2. The autonomous service station of claim 1, wherein said sensor system includes a sensor selected from a group consisting of a camera and a laser.

3. The autonomous service station of claim 2, wherein said commands are voice inputs, and further wherein said central controller responds to said voice input of said vehicle operator.

4. The autonomous service station of claim 3, wherein said service station includes a plurality of service bay lanes, wherein each of said plurality of service bay lanes include an automated robotic arm for autonomously refueling a vehicle.

5. The autonomous service station of claim 4, wherein said fuel tank inlet includes opening of a fuel door and removing of a fuel cap.

6. The autonomous service station of claim 1, wherein said service bay lane includes a second automated robotic arm at a second position for autonomously handing store items to said vehicle operator.

7. The autonomous service station of claim 6, wherein said service bay lane is a drive-thru lane.

8. The autonomous service station of claim 6, wherein said service bay lane is a movable platform for autonomous movement of the vehicle from said first position to said second position.

9. The autonomous service station of claim 6, wherein said store items are pre-ordered items by said vehicle operator at said first position.

10. The autonomous service station of claim 9, wherein said pre-ordered items are ordered through a voice input system at said first position.

11. The autonomous service station of claim 10, wherein said service bay further includes a payment system for paying for the fuel and said store items at said first position.

12. An autonomous service station for refueling a vehicle, the autonomous service station comprising:
a service station including a service bay lane, wherein said service bay lane includes a first automated robotic arm at a first position for autonomously refueling a vehicle;
a sensor system for determining an alignment of the vehicle in said service bay lane, wherein said sensor system determines alignment of the vehicle with said first automated robotic arm;
said sensor system aligns a nozzle of said first automated robotic arm with a fuel tank inlet of the vehicle;
wherein said first automated robotic arm connected to a fuel pump;
a central controller for activating said fuel pump based on a command of a vehicle operator;
said first automated robotic arm refuels the vehicle when said vehicle operator commands said fuel pump and when said sensor system confirms alignment of said nozzle and said fuel tank inlet;
wherein said service bay lane includes a second automated robotic arm at a second position for autonomously handing store items to said vehicle operator;
wherein said service bay lane is a movable platform for autonomous movement of the vehicle from said first position to said second position; and
wherein said store items are pre-ordered items by said vehicle operator at said first position.

13. The autonomous service station of claim 12, wherein said sensor system includes a sensor selected from a group consisting of a camera and a laser.

14. The autonomous service station of claim 12, wherein said commands are voice inputs, and further wherein said central controller responds to said voice input of said vehicle operator.

15. The autonomous service station of claim 12, wherein said service station includes a plurality of service bay lanes, wherein each of said plurality of service bay lanes include an automated robotic arm for autonomously refueling a vehicle.

16. The autonomous service station of claim 12, wherein said fuel tank inlet includes opening of a fuel door and removing of a fuel cap.

17. The autonomous service station of claim 12, wherein said pre-ordered items are ordered through a voice input system at said first position.

18. The autonomous service station of claim 12, wherein said service bay further includes a payment system for paying for the fuel and said store items at said first position.

19. An autonomous method for refueling a vehicle, the method comprising:
providing a service station including a service bay lane, wherein said service bay lane includes an automated robotic arm at a first position for autonomously refueling a vehicle;
determining an alignment of the vehicle in said service bay lane with a sensor system, wherein said sensor system determines alignment of the vehicle with said automated robotic arm;
aligning a nozzle of said automated robotic arm with a fuel tank inlet of the vehicle;
activating a fuel pump based on a command of a vehicle operator, wherein said automated robotic arm connected to said fuel pump; and
refueling the vehicle with said automated robotic arm when said vehicle operator commands said fuel pump and when said sensor system confirms alignment of said nozzle and said fuel tank inlet.

20. The autonomous method of claim 19, wherein said sensor system includes a sensor selected from a group consisting of a camera and a laser.
